(19) United States
(12) Patent Application Publication
(10) Pub. No.: US 2025/0217867 A1
(43) Pub. Date: Jul. 3, 2025

(54) DESTINATION ARTIFICIAL INTELLIGENCE

(71) Applicant: HUBSPOT, INC., Cambridge, MA (US)

(72) Inventors: Sampath James Mallikarjunan, Cocoa Beach, FL (US); Andrei Oprisan, Boston, MA (US); Corey Anthony Braccialini, Denver, CO (US); Lucy Goldberg Solaski, New York, NY (US)

(21) Appl. No.: 19/002,054

(22) Filed: Dec. 26, 2024

Related U.S. Application Data
(60) Provisional application No. 63/615,104, filed on Dec. 27, 2023.

(51) Int. Cl. G06Q 30/0601

(52) U.S. Cl. CPC G06Q 30/0631; G06Q 30/0641

(57) ABSTRACT

Systems and methods are provided for intelligent website user journey recommendations. Contextual user information, of a user accessing a page of a website containing content items, may be identified. The contextual user information and content information for the content items may be input into a model that generates a sequence of content items to recommend to the user. An interface element of the website is populated with one or more content items from the sequence of content items. The interface element may be dynamically updated with content items as the user navigates the website. In this way, the user can directly navigate to the recommended content items through the interface element.

### RELATED APPLICATIONS

This application claims priority to U.S. Provisional Patent Application, titled “DESTINATION ARTIFICIAL INTELLIGENCE”, filed on Dec. 27, 2023 and accorded Application No.: 63/615,104, which is incorporated herein by reference.

### BACKGROUND

A website may provide users with access to a vast amount of content items, such as web pages, videos, blogs, fillable forms, audio, and/or other types of content items. When a user accesses the website, the user may initially view a landing page of the website. Based upon information within the landing page, the user may interact with a user interface (UI) element, such as by clicking a button or link, which transitions the user from viewing the landing page to viewing a different page of the website. In this way, the user may manually navigate amongst content items of the website in order to discover relevant content items and/or perform actions such as learning about a product, filling out a form, purchasing a product, etc. Because the website may contain a significant amount of content items, such as hundreds of pages, there may be a low probability that the user will discover relevant content, and identifying the relevant content may require a lot of manual trial and error navigation amongst the pages to discover desired information.

### DESCRIPTION OF THE DRAWINGS

Embodiments of the present technology will be described and explained through the use of the accompanying drawings in which:

FIG. 1 is a block diagram illustrating an embodiment of intelligent website user journey recommendations, in accordance with an embodiment of the present technology.

FIG. 2 is a flow chart illustrating an embodiment of a method for intelligent website user journey recommendations, in accordance with an embodiment of the present technology.

FIG. 3A is a block diagram illustrating an embodiment of intelligent website user journey recommendations where a model is trained for recommending sequences of content items to users visiting a website, in accordance with an embodiment of the present technology.

FIG. 3B is a block diagram illustrating an embodiment of intelligent website user journey recommendations where user specified answers to qualifying questions are received as current contextual information, in accordance with an embodiment of the present technology.

FIG. 3C is a block diagram illustrating an embodiment of intelligent website user journey recommendations where a sequence of content items are recommended to a user, in accordance with an embodiment of the present technology.

FIG. 3D is a block diagram illustrating an embodiment of intelligent website user journey recommendations where current contextual information is obtained from a user navigating a website, in accordance with an embodiment of the present technology.

FIG. 3E is a block diagram illustrating an embodiment of intelligent website user journey recommendations where an updated sequence of content items are recommended to a user, in accordance with an embodiment of the present technology.

FIG. 3F is a block diagram illustrating an embodiment of intelligent website user journey recommendations where feedback is received from a user, in accordance with an embodiment of the present technology.

FIG. 4 is a block diagram illustrating an embodiment of intelligent website user journey recommendations, in accordance with an embodiment of the present technology.

FIG. 5 is an example of a computer readable medium in which an embodiment of the present technology may be implemented.

FIG. 6 illustrates an exemplary computing environment wherein one or more of the provisions set forth herein may be implemented.

The drawings have not necessarily been drawn to scale. Similarly, some components and/or operations may be separated into different blocks or combined into a single block for the purposes of discussion of some embodiments of the present technology. Moreover, while the present technology is amenable to various modifications and alternative forms, specific embodiments have been shown by way of example in the drawings and are described in detail below. The intention, however, is not to limit the present technology to the particular embodiments described. On the contrary, the present technology is intended to cover all modifications, equivalents, and alternatives falling within the scope of the present technology as defined by the appended claims.

### DETAILED DESCRIPTION

Systems and methods are provided for intelligent website user journey recommendations, such as recommendations that are “intelligent” in relation to how a human user would have a conversation with a human representative or subject matter expert as part of an information decision making process. When a user visits a website, the user must manually navigate through the website to discover content items such as pages of the website that are relevant to a current objective of the user. The website is constructed at design time without knowledge of a particular user's context at a given time, and thus the website is not tailored to nor dynamically adaptable for specific users. A designer must significant waste time and computing resources guessing how to manually construct the website with links for navigation before the website is even published to users for making manual decisions on how to navigate around the website. Thus, the design merely takes into account a generic average user context when designing the website with navigation links.

The current objective of the user may relate to information that is located across multiple content items (e.g., learning about cloud storage, viewing cloud storage options, reading customer testimonials, evaluating cloud storage solution pricing, and finally purchasing a cloud storage solution). Some users may not initially know their current or final objective, which may change as the user navigates the website or re-visits the website. In an example, a user may visit a storage vendor website because a business of the user has a storage need. The user may be in the initial stages of learning about various types of storage software options, such as on-premise storage, cloud storage, high availability storage, disaster recovery storage, multi-tenancy storage, data replication, data backup, etc. The user may be provided with little to no guidance from the website on how to sequentially navigate through different content items of the website along a journey to discover information that will satisfy an objective of the user. For example, if the final objective is to purchase certain storage software that will satisfy the storage needs of the user's business, then the user would first need to learn about storage software options before viewing storage software pricing options. Unfortunately, websites are not organize or capable of leading users along a journey of visiting pages in a particular order that results in an increased probability that the users will achieve an objective. If the user directly navigates to a software product pricing page before visiting pages to learn about how certain software products could solve the storage needs of the business, then the user may ultimately leave the website without accomplishing the objective. However, if the user had first learned about the software products before visiting the pricing page, then the user may end up purchasing a software product that would be an optimal solution for the business.

In some embodiments, as used herein, an objective of a user may be to make a decision, such as an informed decision with knowledge gained from content of the website. The problem to solve is understanding whether inaction (e.g., making a decision to not learn more or otherwise move down buyer's journey) is an informed decision (e.g., learning that a product is not a solution for their particular problem) or is not an informed decision because the user prematurely abandoned a decision making process because the user did not have the right information at the right time in a sequence that would have led the user to be able to adequately make an informed decision (e.g., the user never saw information about how the product could solve similar problems that the user is experiencing).

Without guidance, a user is left to manually “click around” a website with the hopes of discovering relevant content and information. This is because conventional website design (conventional website link architecture with hierarchies or related data that often do not reflect hierarchies of relevant data in an order consumed by users for making informed decisions) is not dynamic in nature, and is limited to making content and information relevant to a particular page of the website (e.g., product training on a product training page), which may be useful to a current context or amount of information required by the user to successfully make an informed decision. Because the website may include a significant amount of pages, the user may have a statistically reduced likelihood of navigating through pages in an optimal sequence that would lead to achieving the user's objective (similar to a conversation between a potential client and a sale representative where certain information is provided to the potential client based upon a series of questions and answers between the potential client and sale representative). Often, users may leave a website without ever accomplishing their objectives and goals because the users were never able to locate relevant content, or experience content in a particular sequence that would help lead to the user on a journey to accomplishing their objective (e.g., first learning about storage software, then learning about how certain storage software products are best suited for certain business use cases, next learning about pricing options and viewing side-by-side product comparison information, and finally landing at a page where the user can easily purchase a storage software product after adequately learning about the storage software product). This lack of structured guidance stems from the absence of a dynamic real-time engine capable of synthesizing user behavior signals (e.g., dwell time, scroll depth, or link-hover data) and correlating them with historical aggregated usage patterns and correlating outcomes. Thus, users are left to rely on external search engines to hopefully locate information that will help them make an informed decision.

The disclosed techniques provide a technical solution that improves upon conventional websites and website navigation. The disclosed techniques provide an Al guided experience the improves upon conventional website design of links to related content, which often does not led a user along a journey of experiencing content that will lead the user to being able to make an information decision as the journey may include an ordering of unrelated content (e.g., suggesting a page that would be an obvious next step on a decision making journey). The disclosed techniques leverage AI models configured to not only present information accretive content, but also to do so in a way that is cognitively comfortable for the user

Custom tailored machine learning and artificial intelligence is leveraged for generating, training, and utilizing customized models to output recommendations of content item sequences for users. A recommendation may include a particular sequence or ordering of content items for a certain user to navigate as part of a user journey through the website that will result in an increased probability of satisfying an objective for the user. In one embodiment, the solution includes a multi-layer architecture, comprising (1) a real-time event-collection pipeline; (2) an in-memory streaming analytics engine that continuously updates user-state features (e.g., categories of pages visited, time spent, or explicit user feedback); and (3) an inference layer that runs a recommendation model to output prioritized sequences of webpages. The disclosed technique leverages customized models that are trained to output the recommendations. The recommendations are leveraged to transform how users navigate and interact with websites.

In some embodiments, the model is trained by analyzing hundreds of thousands of hours of recorded calls (e.g., sales calls between prospects/users and human sales or support reps; troubleshooting phone calls with support reps; etc.). The calls (conversations) were organized into Question< > Answer Pairs, and then sequenced into Turns of conversations. The model may be implement by an AI agent that communicates (“talks”) with a user by sequencing content in a way similar to humans having a conversation insofar as displaying content in a specific order.

The model is also trained to learn when there is enough information to stop asking questions. The conversations may indicate when a human agent learns enough information or particular information that matters more than other information in order to continue, whereas a convention computer continues asking for all information that it is supposed to ask such as fields in a form to fill out. Not only does the disclosed techniques provide an innovating method for determining the contextual value of next-step information presented, but also how data is collected and analyzed for training. LLMs provide the ability to understand the context of the turns in conversations beyond conventional machine learning applications that merely provide for basic correlation and prediction of next-step content to present. In this way, the model is trained by analyzing a large volume to human-to-human conversations, associated contexts of the conversations, and subsequent outcomes from the conversations (e.g., was the user provided with a solution to a problem; did the user purchase a product or not; etc.)

The recommendations are dynamically generated and updated as the user navigates through the website in order to “lead” the user through a journey of sequentially exploring information of content items provided by the website in a manner similar to a user having a conversation. For example, by employing a reinforcement learning agent with continuous feedback loops, the system monitors clickstream data in real-time, assessing user engagement (e.g., dwell time thresholds) and adjusting subsequent recommended pages. This agent may employ a reward function correlating certain navigations (e.g., from an introductory product page to a testimonial page) with higher purchase likelihoods or other positive outcomes from an informed decision making process, thereby adapting to user inputs on-the-fly. The recommendations are used to provide a conversational user experience similar to a conversation with a user or chatbot that leads the user through information and answers until an objective of the user is satisfied such as purchasing a storage software solution tailored to the business of the user. To facilitate this conversational paradigm, the system can optionally incorporate a natural language understanding (NLU) module to parse user's typed questions or queries and map them to relevant recommended pages in the user journey. The model may be custom configured and trained such that for a given type of user (e.g., a user with a particular age, an association or role at a business, interests, hobbies, location of residence, demographic information, browsing history, purchase history, information extracted from social media posts and email, etc.), the model may determine a sequence of content items that other similar users viewed in a particular order before achieving a similar objective as the user. In certain implementations, user-specific features and/or other information (e.g., context of a user and outcomes in a sequence of a decision-making process, beyond merely current content and user-specific features) are converted into high-dimensional embeddings (e.g., 512-dimensional vectors) that capture user intent, while content items (pages, videos) are likewise represented by embedding vectors. A similarity metric (e.g., cosine similarity) can then be employed to match user embeddings to the most relevant content embeddings. These user-specific attributes may be transformed into embedding vectors in a high-dimensional latent space, enabling the model to cluster similar users or cohorts (e.g., CFOs of small businesses) and derive sequence recommendations that led to measurable outcomes (e.g., a purchase event). For example, other CFOs of similar small restaurant businesses may have viewed certain pages of a storage vendor website in a particular order before purchasing a storage software product, and thus the model may output a recommendation of similar pages according to a similar ordering for a CFO having a similar objective. In this way, the recommendation may be provided to aid the user in journeying through the website along a path of viewing content items such as pages of the website until the objective of the user is met. The journey may relate to introducing the user to certain basis concepts, explaining more detailed concepts, providing the user with reviews and testimonials, showing the user product comparison and pricing information, and leading the user to a product purchase page.

The model may be trained with data corresponding to users navigating amongst content items such as pages of a website and actions performed by the users (e.g., click stream data of websites and contextual information about the content items such as descriptions and topics of content items) and/or with information and objectives of the users (e.g., demographic data such as location, job title, interests, hobbies, purchase history, search history, etc.). In some embodiments, the system's data ingestion layer aggregates tens of millions of historical click events from multiple websites or domains, which are then de-duplicated, timestamped, and annotated with user or session-level metadata. This raw dataset is subsequently fed into a feature engineering phase where advanced constructs like user journey “path embeddings” and temporal session graphs are generated, capturing the chronological relationships between visited pages. The model may utilize machine learning and clustering techniques to cluster the data and information into clusters of similar users and clusters of content items (pages of websites) during training. The model may be used by a platform, such as a large language model (LLM) platform, to perform localized inferences of what content to recommend to a user, an order with which the user should view the content, what questions to ask the user in order to obtain contextual user information to input into the model, and an overall journey for the user through the website, which may dynamically change depending on what pages the user visits along the journey.

An additional aspect of the disclosed system architecture involves a predictive orchestration layer that manages both the training and serving phases of these models. During the training phase, a model-building pipeline (which can include a combination of deep neural networks, gradient boosting machines, and clustering algorithms) is run on distributed compute clusters (e.g., Apache Spark™ or similar). The pipeline's objective is to learn how best to map a user's contextual signals (e.g., purchase history, indicated business needs, website content “affinity” scores) to a recommended sequence of content items. To mitigate overfitting and ensure broad generalization, the system can incorporate cross-validation over multiple user segments. At inference time, an online feature store continuously updates fresh signals from the user's current session, enabling the recommendation engine to dynamically adapt sequences based on real-time behaviors (e.g., skipping certain pages, or spending extra time on in-depth product comparisons). This holistic orchestration ensures that the user receives updated, context-driven guidance at each click, substantially improving both engagement metrics and conversion rates, while reducing the cognitive burden of “clicking around” blindly.

The disclosed innovation guides a user in navigating an appropriate sequence of content in a particular order that will assist the user in decision making processes, such as whether the user should fill out a form, sign up for a newsletter, contact a sale representative, request a demo, create a service ticket for troubleshooting an issue, engage with a chatbot, etc. In this way, the user is provided with the right information at the right time so that the user does not abandon a decision making process even though relevant content exists on a website, but the user never saw the relevant content in a proper order that would have aided the user in their learning/education process and/or the decision making process.

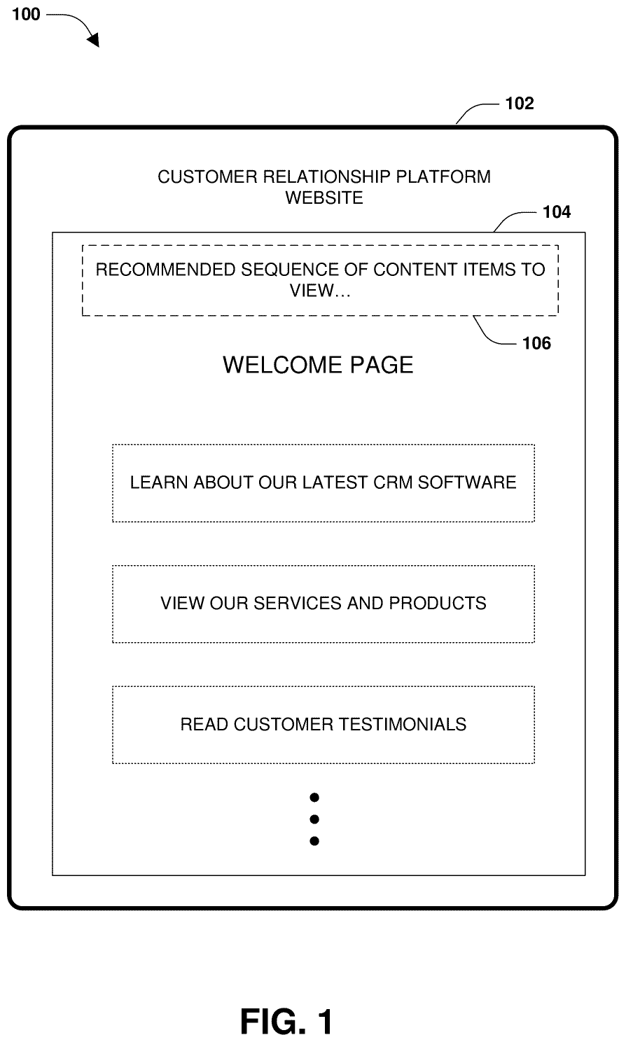

FIG. 1 is a block diagram 100 illustrating an embodiment of intelligent website user journey recommendations. A user may access a website through a user device 102, such as a customer relationship platform website of a vendor that provides customer relationship management (CRM) services and products. The customer relationship platform website may include numerous content items, such as pages, amongst which the user can navigate. For example, the website may include a welcome page 104, a page where the user can learn about CRM software, a page where the user can learn about services and products, a page where the user can read customer testimonials, a page where the user can view product documentation, a page where the user can purchase services and software, and/or other content items such as videos, documentation, audio, blogs, forms, etc.

Contextual user information may be identified for the user accessing the website, such as from user click log data. The contextual user information may relate to answers provided by the user in response to qualifying questions asked of the user through the website or from information obtained from various data sources (e.g., email, social media, a user profile, browsing history, purchase history, etc.). Content information for content items of the website may be retrieved. The content information may relate to topics, descriptions, and information provided by pages of the website (e.g., a page related to product pricing, a page explaining cloud storage, a checkout page, a blog, a video, images depicting how cloud storage operates, etc.). In one embodiment, these inputs are transformed into tokenized sequences (for textual content) and one-shot (e.g., machine learning that recognizes new objects with a single example; a type of prompt for generative AI where learning is performed by comparing similarities and differences) or continuous embeddings (for categorical user data) before being passed into the machine learning pipeline. The model can then use attention mechanisms to weigh the importance of each data element in determining the best content sequence. The contextual user information and the content information is input into a model trained to generate recommendations of what content items to show users as part of user journeys through websites in order to increase the probability that the user will achieve an objective such as learning about a product, filling out a form, purchasing a product, joining a social media group, writing a review, etc.

The model may output a recommendation of a sequence of content items to recommend to the user. The model may identify content items that were viewed by similar users with similar objectives (e.g., users with similar businesses that ended up purchasing storage software after viewing particular content items). For example, a past user visiting the website (or a different or similar website) may have viewed a homepage, a page describing cloud storage, a page with customer testimonials, a page with product pricing, and may finally purchase a cloud storage product through a checkout page. The model may determine that if the user views the content items according to an order defined by the sequence of the content items, then a probability that the user will achieve the objective will increase, such as an increased probability that the user will purchase a cloud storage solution. In certain implementations, the recommendation algorithm may rank these content items using a multi-factor objective function, which considers user similarity metrics, anticipated time on page, probability of conversion, and other engagement indicators derived from historical data. One or more of the content items may be populated into an interface element 106 such as a widget of the website. In some embodiments, a representation of a content item may be populated within the interface element 106, such as an image, description, and/or link to the actual content item of the website. In this way, the user can click on a content item (a representation of a content item) in order to directly navigate to the content item such as a particular page of the website. As the user navigates to different content items of the website, new/updated recommendations of sequences of content items may be generated based upon current context of the user navigating the website (e.g., a current context may relate to a content item recently or currently viewed by the user since a last recommendation was generated). Accordingly, the interface element 106 may be dynamically updated with different sequences of content items based upon detected changes in the current context of the user navigating the website.

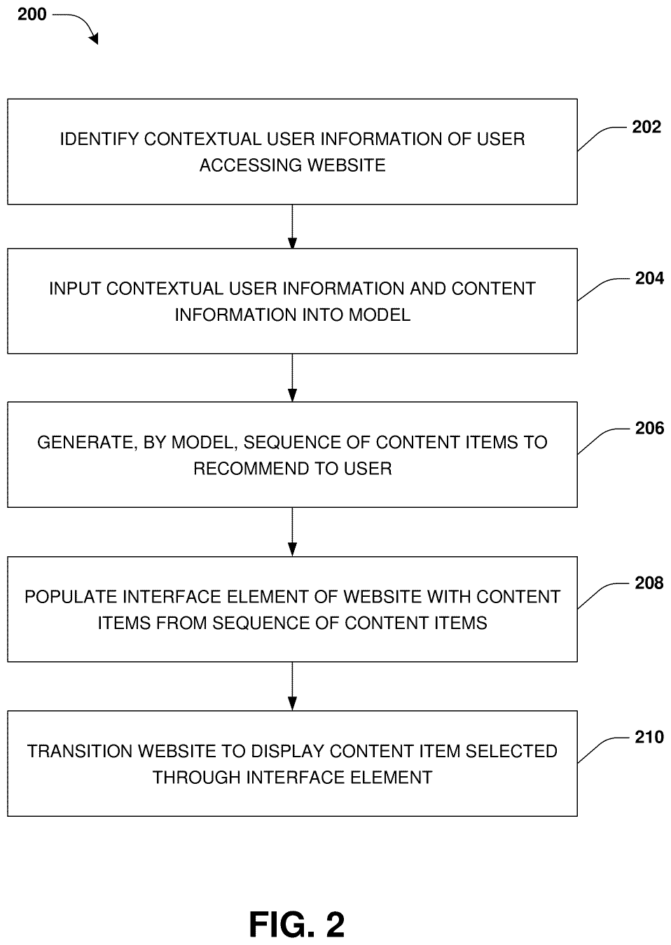

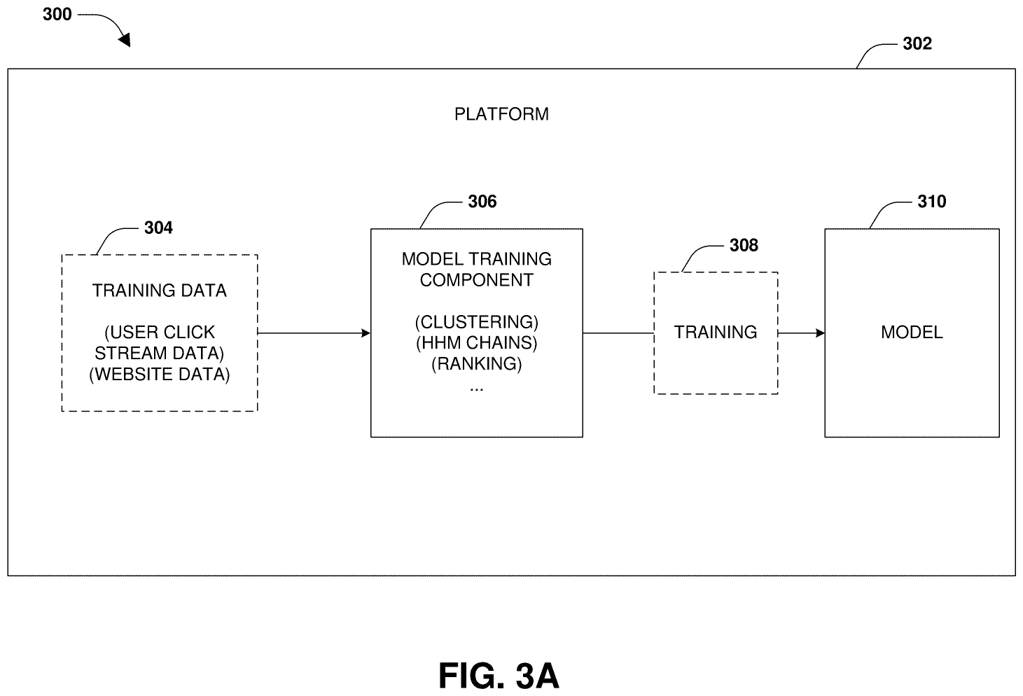

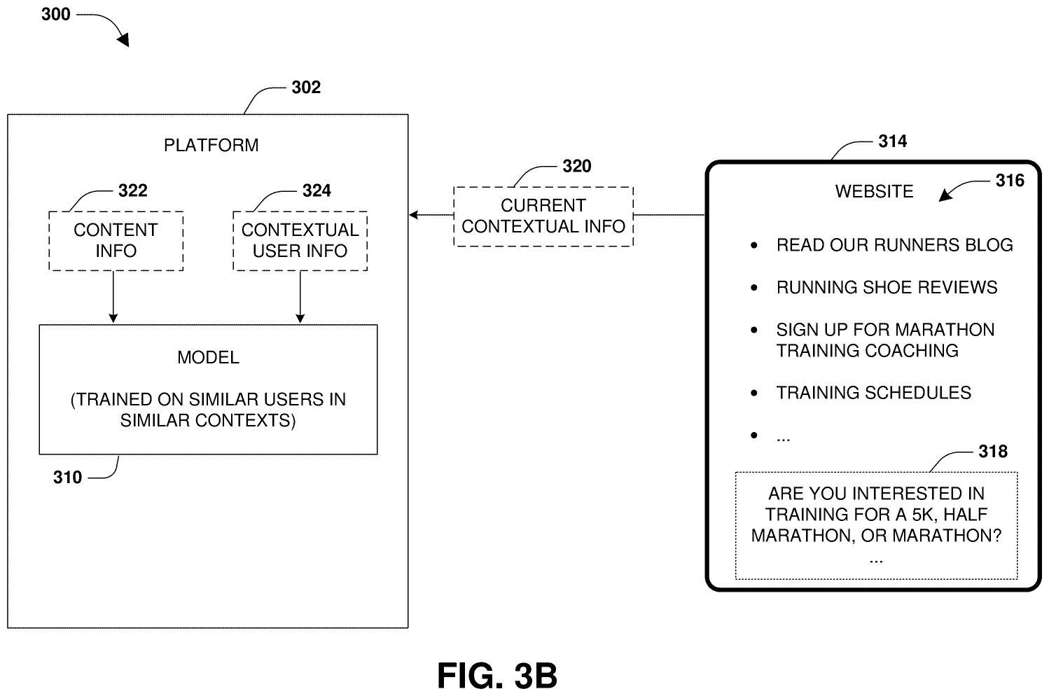

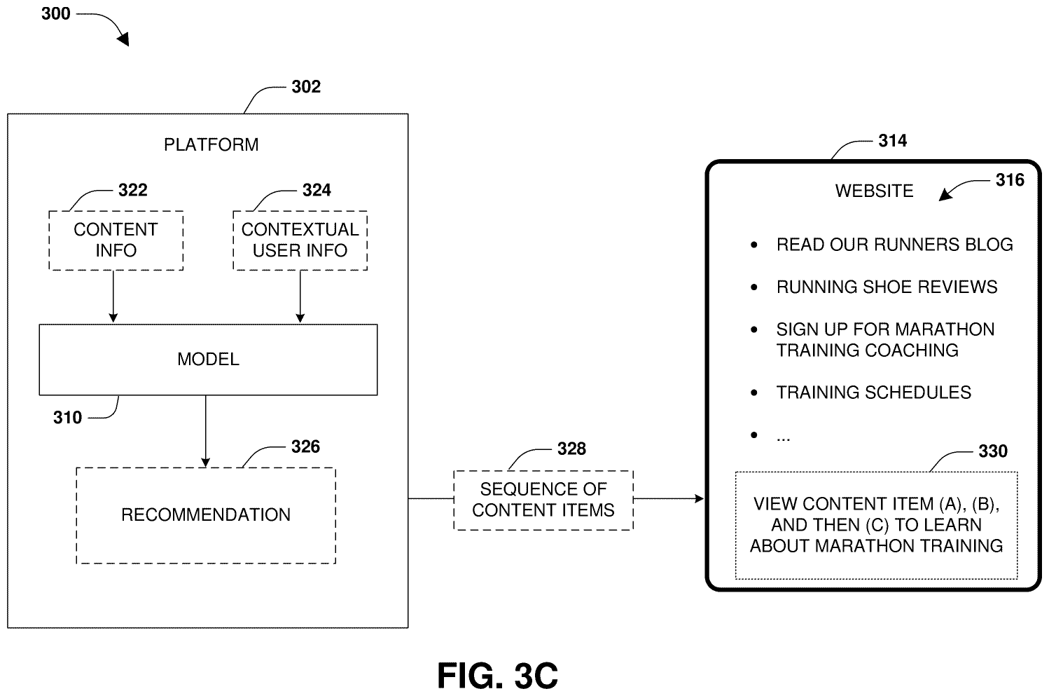

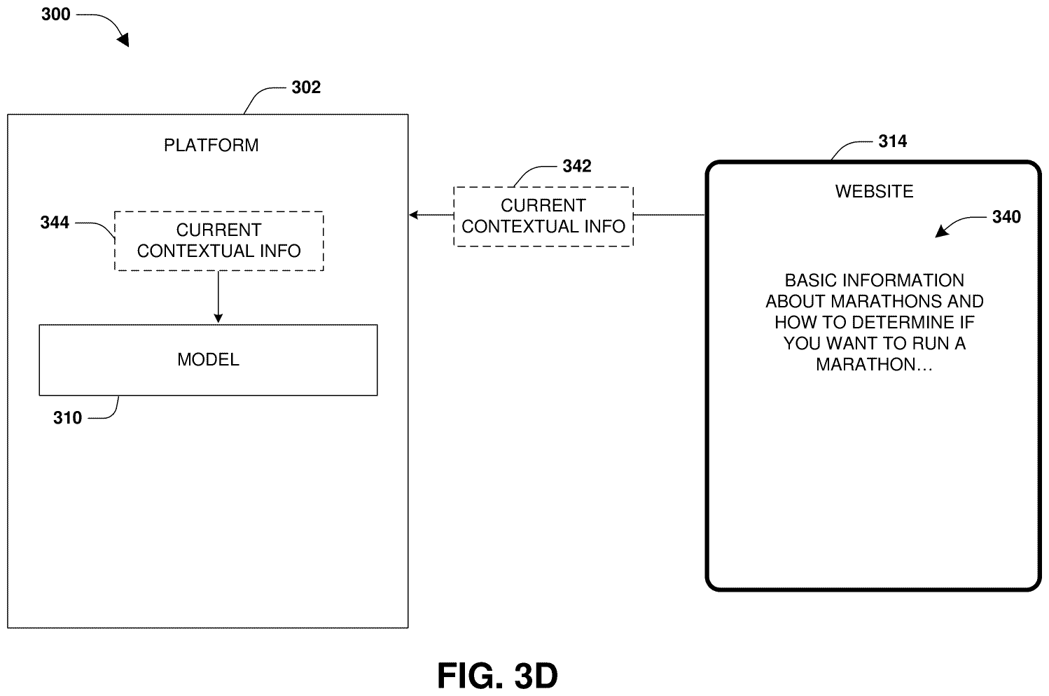

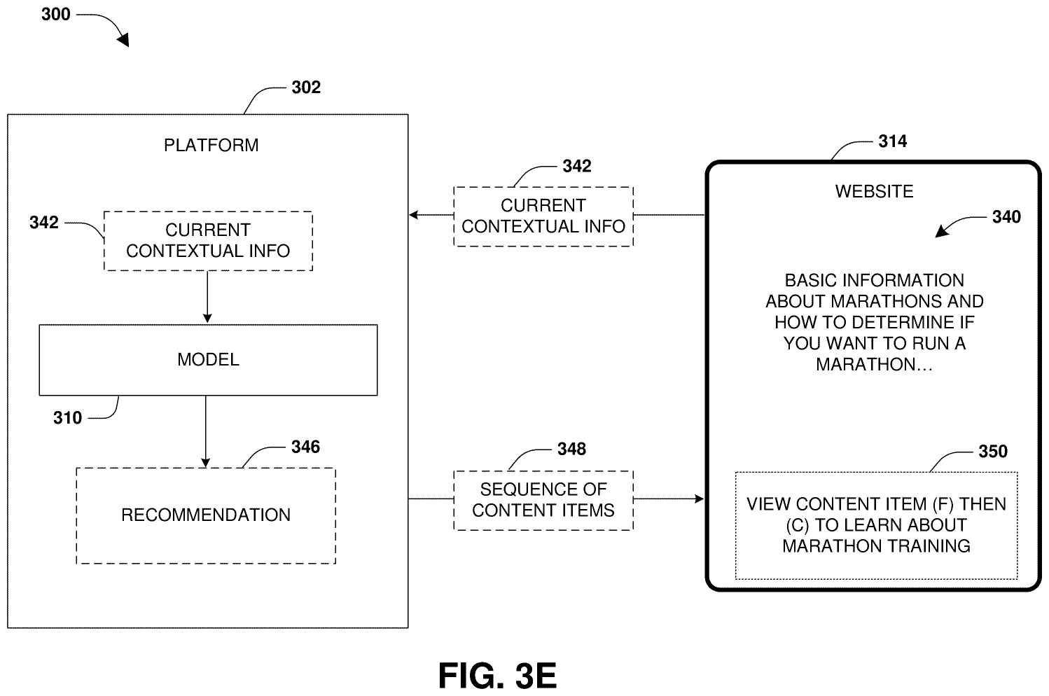

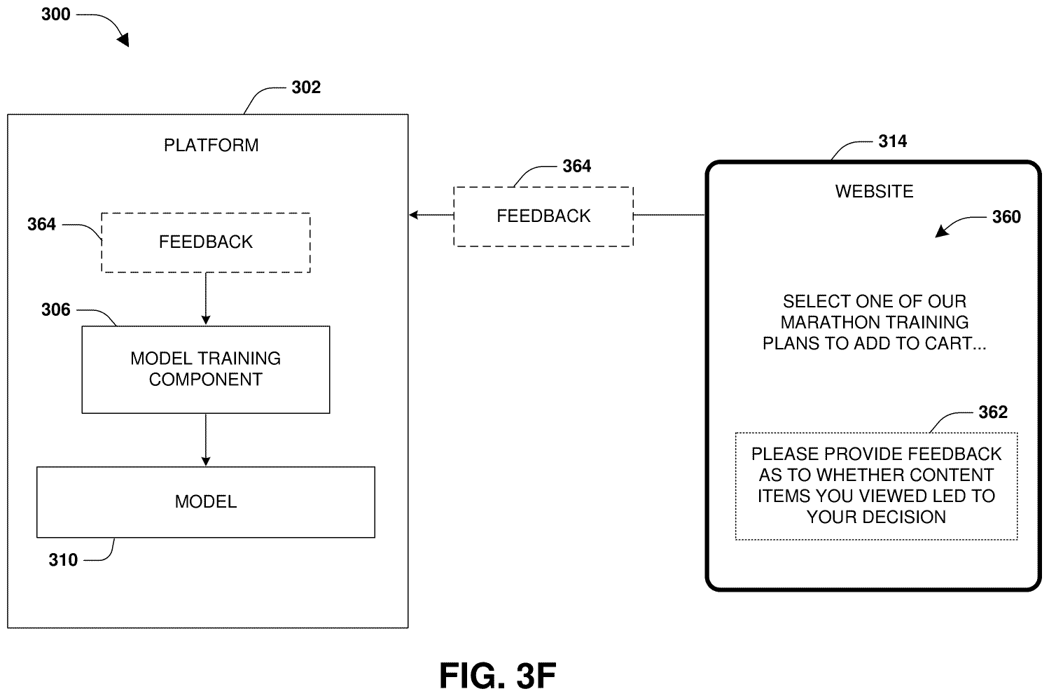

FIG. 2 is a flow chart illustrating an embodiment of a method 200 for intelligent website user journey recommendations, which is described in conjunction with system 300 of FIGS. 3A-3F. A platform 302 may be implemented as a computing environment that implements various services, such as a website service hosting a website, a customer relationship management (CRM) database and service, a machine learning and artificial intelligence service (e.g., a large language model platform, etc.). The platform 302 may host a model 310 that is trained 308 by a model training component 306 to perform localized inferences for generating suggestions of content items to provide users, qualifying questions to ask the users, and guidance for navigating the users through journeys across content items of the website.

The model training component 306 may train 308 the model 310 using training data 304, as illustrated by FIG. 3A. In some embodiments, the training data 304 may comprise user click stream data corresponding to a user click log of users clicking on interface elements of a website, which may be indicative of content items (pages) visited by the users. The training data 304 may indicate that a user visited a landing page of an exercise website, viewed a running overview page of the website, viewed a training schedule page of the website, watched a marathon training video, and signed up for a marathon training class. The training data 304 may include this type of information for a plurality of users that visited the website and/or other websites. The training data 304 may include website data corresponding to descriptions and topics of content items of the website, which may be obtained by analyzing HTML and/or other data of the website. The website data may describe a topic and what is included within a page, such as how the page include marathon training workouts and a video with marathon training tips.

In some embodiments, the model 310 is trained 308 by the model training component 306 with user click stream data corresponding to users interacting with content items of the website. The model 310 is trained with information about the users (e.g., demographic information, user profile information, answers to qualifying questions asked from the users, etc.) and resulting actions performed by the users in relation to objectives set for the users navigating through the website (e.g., an objective of a user learning about a particular product by watching a video about the product, an objective of the user purchasing the product, an objective of the user submitting a form, etc.). In this way, the model training component 306 may train the model 310 to utilize clusters of content items, clusters of users, hidden Markov models and chains, ranking, and/or other machine learning functionality to generate inferences (recommendations) of content items to recommend to users. For instance, the training pipeline can involve constructing user transition graphs (i.e., Markov chains) that reflect how users progress from one page to the next, augmented by reinforcement learning methods to identify rewarding sequences (e.g., a purchase event). That is, the model 310 is trained to generate recommendations of what content items to show users as part of user journeys through websites that led to satisfying objectives for the users. In some embodiments, the model is trained to analyze human-to-human conversations to identify “turns” in the conversations, and to provide sequence content exposure to users in a human-conversation manner, such as where the model is trained on past conversation with context and outcomes of the conversations (e.g., the user calls about a phone problem, and ends up purchasing a new phone).

The platform 302 may deploy the model 310 for dynamically generating recommendations to display to a user in real-time as the user is browsing a website through a user device 314, as illustrated by FIG. 3B. In some embodiments, the model 310 may be utilized to generate a set of qualifying questions to ask the user, which may be displayed through an interface element 318 of the website. For example, a qualifying question may be “are you interested in training for a 5k, half marathon, or marathon?” In some embodiments, the model 310 may have been trained to minimize a number of qualifying questions to include within the set of qualifying questions, which may lead to a more efficient exchange of information with the user for obtaining contextual user information 324 about the user. The model 310 may also inform the user as to how information provided is intended to increase the user's willingness to provide additional information about themselves (e.g., so that more accurate recommendations of content sequences can be provided to help the user make an informed decision). The user may submit user specified answers to one or more qualifying questions through the interface element 318, which may be received as part of the contextual user information 324. Accordingly, during operation 202 of method 200, the contextual user information 324 may be identified for the user accessing a page 316 of the website that contains a plurality of content items (e.g., pages, videos, blogs, forums, social media posts, images, etc.).

The contextual user information 324 may be extracted from various data sources and services, such as a social media profile, a business website or other website associated with the user, a user profile, email, browsing history, purchase history, demographic information, locations visited by the user, etc.). In some embodiments, the contextual user information 324, the model 310, and/or other information input into the model 310 or output by the model 310 may be stored within the platform 302 (as opposed to an external service that could pose security concerns) and/or stored within local storage associated with the device 314 or a browser accessing the website. In this way, such information is protected from being accessed by services or analytics other than by the platform 302. Additionally, in some embodiments, encryption at rest and in transit may be applied to all personally identifiable information (PII) so that user data remains secure while being utilized by the recommendation model. For example, the information may be made accessible to a recommendation engine of the platform 302 hosting the model 310 for generating recommendations of content items to show users (as opposed to browser cookies that could be accessed by other services or analytics), and is restricted from being accessed by other services. In some embodiments, LLMs (e.g., open source LLMs) may be leveraged to ensure that data used to train the model 320, data being analyzed, and other data sources and flows are retained within computing systems controlled by a platform service, which improves security and is different than using third party cloud systems because data is contained to secure computing systems.

Additionally, context information for the plurality of content items of the website may be obtained by the platform 302 for input into the model 310. The content information may comprise descriptions, topics and/or other information about the content items, which may also include current contextual information 320 of the user navigating the website. The current contextual information 320 may relate to what content items the user is currently or has already viewed, actions performed the user (e.g., the user filling out and submitting a form, the user watching a video, the user accessing a customer service chat bot, etc.), and/or other contextual information related to the user accessing the website.

During operation 204 of method 200, the contextual user information 324, the content information 322, and/or the current contextual information 320 are input into the model 310 trained to generate recommendations of what content items of the website to show users as part of user journeys through the website. This model 310 may be accessed via an inference API, which handles real-time feature engineering—such as generating session features (click counts, time spent) and user-level features (location, role, etc.)—before passing them as input tensors to the trained machine learning model. During operation 206 of method 200, the model 310 uses the contextual user information 324, the content information 322, and/or the current contextual information 320 as input to generate a recommendation 326 of a sequence of content items 328, as illustrated by FIG. 3C. The recommendation 326 may be generated as an inference specifying a sequence of content items to recommend to the user that will result in an increased probability of satisfying an objective for the user. The sequence of content items 328 may be defined as a journey for the user through the website that will help guide the user along a path to discover, consume, and/or interact with information that will help lead the user to satisfying the objective.

In some embodiments, the model 310 generate the sequence of content items 328 to include content items that similar users viewed along journeys of navigating the website (or a different or similar website) that resulted in the users performing actions related to the objective. For example, the user may provide a user specified answer that the user is interested in marathons. An objective may be specified by the website 314 as input into the model 310. The object may be defined for users having an interest in marathons. The objective may be for such users to sign up for a marathon training program. In this way, objectives may be defined as input into the model 310 based upon actions, activities, or events that are desired for certain types of users (e.g., an objective for a new runner to learn about running groups; an objective for a long time runner to write a blog; etc.). In some embodiments, an objective for a user may dynamically change as the user navigates the website, such as where an objective for a user to sign up for a marathon is changed to an objective for the user to purchase running shoes based upon the user navigating to running shoe pages of the website.

In some embodiments, the model 310 may identify a content item that was viewed by a past user having one or more similar attributes as the user. For example, the past user may have expressed an interest in marathons. The past user may have performed an action related to the objective for the user, such as to sign up for the marathon training program. The content item may be included by the model 310 within the sequence of content items 328 to recommend to the user. In this way, the sequence of content items 328 may be similar to sequences of content items navigated amongst by similar users as the user given the objective for the user being similar to actions performed by the similar users. In certain implementations, a cohort analysis sub-module tracks historical user segments, updates them in near-real-time, and tags each user path with success metrics (e.g., sign-up conversions, time to purchase), thereby refining the recommended sequence and providing ongoing feedback loops to further improve model accuracy.

In some embodiments, the model 310 may cluster content items of the website into clusters. In some embodiments, a cluster may include content items that were sequentially viewed by one or more users while navigating through the website with certain objectives (e.g., a first cluster may include pages that users navigated before purchasing shoes; a second cluster may include pages that users navigated before signing up for a newsletter; a third cluster may include pages that users navigated before purchasing a training program; etc.). In some embodiments, a cluster may include content items that relate to a similar topic (e.g., pages with running shoe reviews, pages with training advice, etc.). The model 310 may cluster users having similar attributes that performed similar actions (similar objectives) after navigating across the website. The model 310 may utilize the clusters to identify a cluster of users similar to the user, and a cluster of content items viewed by the users similar to the user. The cluster of content items may be used to construct the sequence of content items to recommend to the user. The clusters may be used to crate cohorts for users where a certain type of user visited certain content items (pages) in a particular sequence with certain end results (e.g., leaving the website, performing an action such as buying a product, signing up for a newsletter, etc.). The cohorts are used to drive the recommendation engine to use the model for generating recommendations. In some embodiments, the clusters are generated based upon proximity/similarity of user journeys through the website for specific objectives. In some embodiments, as part of generating a recommendation of a sequence of content items, the model may disqualifying multiple pages that relate to a similar topic so that the user is not just navigating amongst similar pages (e.g., the model will ensure that a sequence of content items are not just all content items about running shoes), but is instead being led through different pages along a journey to reach an objective. Additionally, a weighting mechanism may be applied so that each page in the cluster is scored based on page engagement level, average session duration, and exit rates, ensuring that the recommended sequence is both topically relevant and engaging.

During operation 208 of method 200, an interface element 330 may be populated with one or more content items (representations of the content items) from the sequence of content items 328. In some embodiments, the interface element 330 is populated with a series of representations of the content items, such as textual representations, image based representations, etc. The representations may link to the actual content items such that if a user clicks on a representation of a content item, the website is transitioned to displaying that content item. In some embodiments, a title, a text description, and/or an image are displayed as a representation of a content item. In some embodiments, the interface element 330 may be a widget. In some embodiments, the interface element 330 is populated with representations for a series of content item (A), content item (B), and content item (C) for the user to learn about marathon training. During operation 210 of method 200, in response to the user interfacing with a content item (a representation of a content item (A) corresponding to page 340 of the website) through the interface element 330, the website is transitioned to displaying the content item such as the page 340 with basic information about marathons, as illustrated by FIG. 3D.

Based upon the user navigating within the website such as to the page 340, the platform may obtain current contextual information 342 related to how the user navigated to the page 340 and/or any other actions performed by the user (e.g., the user clicking or hovering over certain content or interface elements of the page 340, such as the user watching a video on the page 340, invoking a chat bot, filling out a form, etc.), as illustrated by FIG. 3E. The current contextual information 342 may relate to prior content and information that brought the user to a current point in a decision making process, which may be used by the model 310 to correlate the current point of the user in the decision making process to a “turn” position of a human-to-human conversation flow (used to train the model 310) in order to better understand the content that should be viewed next in the decision making process for making an informed decision. In an example, a user may be on a product comparison page, and a pricing page may be a logical next step, but if the user came from an ad link or social media URL, then the user may need other information or sequence of content compared to if they viewed other information before such as a lengthy blog article already educating the user on product features where the user may be less ready to proceed with a decision despite being at a same page as other similar users that may have previously viewed different content before arriving at the page. The current contextual information 342 may be input into the model 310 to generate a recommendation 346 of an updated sequence of content items 348. In one embodiment, the model 310 employs a reinforcement learning approach where it continuously updates a Q-value or policy gradient based on user interactions (e.g., dwell times, bounce rates), thereby improving subsequent recommendations in real-time. An interface element 350 may be populated with one or more content items from the updated sequence of content items 348, such as representations of content item (F) and content item (C) to view as part of learning about marathon training. In this way, different sequences of content items may be dynamically recommended to the user as the user navigates the website.

In some embodiments, an output of the model 310 is evaluated to detect whether the website includes a recommended content item within a sequence of content items recommended for the user. In some embodiments, if the website does not include the content item, then a notification with instructions to create the recommended content item for inclusion within the website may be generated and provided to a user. In some embodiments, if the website does not include the content item, then the recommended content item may be generated such as through generative artificial intelligence (AI) using a generative model. Previously, website designers and content writers had to basically guess on what content should exists on a website based upon what users might want to know. The disclosed techniques can tell the website designers and content writers what questions human users were asking human sales reps or other humans in specific contexts/stages of an information decision making journey for which there is not currently pages/content on the website containing sufficient answers. That is, as part of training the model 310 on the human-to-human conversations, the model 310 can identify questions users asked human support and sales reps that the website did not have pre-generated/existing content as answers. In this way, the website may be updated on the fly to include the recommended content item, or the content items can be surfaced to the website designers and content writers to generate manually if necessary. For example, a text generation model (e.g., a GPT-based architecture) may automatically create a landing page draft covering a missing topic (e.g., a new type of storage solution; content tailored to a specific type of user and their context for a new type of storage solution such as where generative AI is used to create content covering missing topics insofar as no content hyper specific to a type of user exists because the website or business has not seen an exactly similar user type before), which is then reviewed by an administrator before deployment. This automated content creation expands the scope of the website to better serve user journeys and ensures more comprehensive coverage of user objectives.

In some embodiments, feedback 364 may be requested from the user, such as through an interface element 362 within a page 360 of the website currently being viewed by the user, as illustrated by FIG. 3F. The timing or page through which the feedback 364 is requested may relate to the user performing a particular action related to an objective for the user, such as the user reaching a marathon training plan page to purchase a marathon training program that would satisfy the objective set for the user. The feedback request may ask the user as to whether certain content items helped the user, were relevant, led the user to perform an action related to the objective for the user, etc. The feedback 364 may be used by the model training component to train the model 310. The model 310 may be trained by modifying one or more weights used to select or rank a content item mentioned in the feedback 364. If the feedback 364 is negative where the user indicates that the content item did not help or was not relevant, then the one or more weights are modified so that the content item is selected or recommended less often or not at all by the model 310 for similar users with similar objectives. In this way, a weight associated with a content item may be modified so that the content item is recommended less or not at all. In some embodiments, a weight for a cluster that includes the content item may be modified so that content items from the cluster are recommended less often or not at all by the model 310 for similar users with similar objectives. In this way, more relevant and helpful recommendations may be output by the model 310.

In some embodiments, any user behavior is received as feedback, even lack of action or leaving the website (site abandonment). Any action performed by a user or any action a user does not take is received as feedback to train the model 310 to better understand how to optimize the experience (recommended journey of content to explore according to a certain order) for future users of a similar user type, timing, and context. The model 310 is trained based upon positive feedback of what outputs improved a user's experience towards an objective and negative feedback of what outputs did not improve or hindered the user's experience towards the objective.

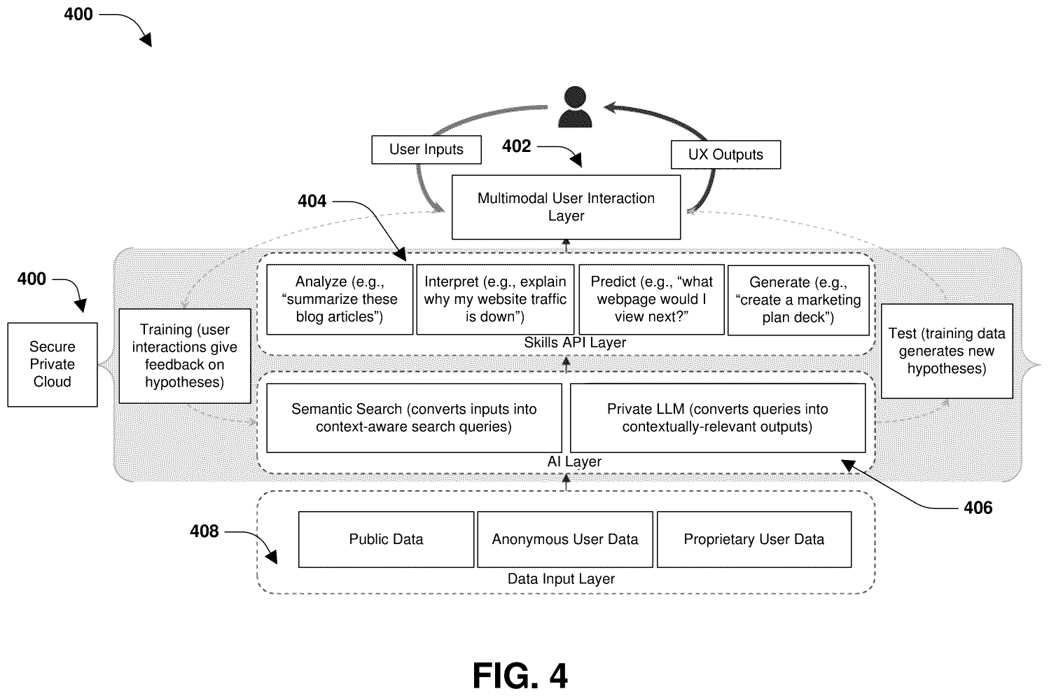

FIG. 4 is a block diagram illustrating an embodiment of intelligent website user journey recommendations. The disclosed techniques may be implemented by a platform 400 that includes a multimodal user interaction layer 402. The multimodal user interaction layer 402 may receive user inputs from a user and provide user experience outputs back to the user. For example, the multimodal user interaction layer 402 may receive website browsing and interaction data from the user interacting with a website, and may provide recommendations of content items for the user to view. A skills API layer 404 may perform analysis for the user (e.g., summarizing blog articles for the user), interpretation for the user (e.g., explaining why website traffic is down), prediction for the user (e.g., what content item or page of a website to visit next), and/or generation for the user (e.g., creating a marketing plan deck, creating a content item or page to include within a website based upon the content item or page being recommended to a user browsing the website, etc.). The skills API layer 404 may leverage an AI layer 406 that may host various machine learning models and/or AI functionality, such as semantic search and/or private large language models that convert inputs into context-aware search queries. The models and AI functionality of the Al layer 406 may be trained based upon training data to generate new hypotheses (e.g., recommendations of content items and pages, of a website, for a particular user to visit) and trained from user interactions and feedback on the hypotheses. The skills API layer 404 and/or the AI layer 406 may be hosted within a secure private cloud for improved security where other services and analytics cannot access such information. The platform may include a data input layer 408 that may provide access to public data, anonymous user data, and/or proprietary user data that could be used as contextual information that is input into a model that generates recommendations of content items for users to view.

In some embodiments, strategic domain awareness is provided by the platform 400. The strategic domain awareness provides monitoring of data sources to determine whether other websites provide similar content as a website for which intelligent website user journey recommendations is provided by a model, and content from the websites may be extracted and used for training the model. The strategic domain awareness provides hallucination as a feature that creates things that sound like they should be true based on product features, economics models, and other strategically relevant data inputs—i.e. things an AI might hallucinate that do not exist, but maybe they should exist and be built by the company if AI is hallucinating that they already do exist (e.g., a content item should be built for a website as part of a sequence of content items users should experience while journeying through the website). The strategic domain awareness provides content strategy by analyzing chats, sales calls, etc. to identify questions human prospects ask human employees and identifying questions people ask for which there aren't already good answers on the website. These questions are then fed to verify that the website has answers people may be looking for via search engines that they wouldn't have otherwise known to create content for. Accordingly, content items not provided by a website may be generated for the website.

The platform 400 may provide for a generative AI UX for websites. For all users, the platform 400 provides link preview with generative context (e.g., an interface element populated with recommendations of a sequence of content items) based on known data about the user as well as the context of the content that's linking to the destination content. The platform may provide for smart navigation. Instead of showing users “Related Content”, smart navigation asks the user for the minimum amount of information required to guide them to the most useful pre-existing site content items based on what the model knows about the user (from user inputs) as well as what content the users have seen and what content the model predicts that the users should see next based on analyzing previous conversations (e.g., conversations between potential client and sales reps, conversations between users and chatbots, conversations between users and customer service agents, etc.) and content journeys to create “turns” in recommending content the same way that conversations have “turns”. For known users, the platform generates content for individual users such as prospect customers and/or existing customers. The platform 400 may generate personalized demo videos for the users that are custom generated and tailored to the users, such as based upon user contextual information (e.g., a demo video may be tailored to what information a user seeks as opposed to general information for all users, such as where the demo video shows how a product will solve a specific problem of this specific user).

The platform 400 may provide for data aggregation, analysis, training, and synthesis for use in training the model for generating recommendations of sequences of content items to recommend to users. The data aggregation may aggregate live chat, recorded calls, website content, platform 400 ecosystem content, CRM and other outcome analytics data, and/or other data used to identify what content items helped achieve an objective for a customer. The analysis may be performed for solving information grain in content journeys and generation, and may utilize “curious” AI (knowing when to ask qualifying questions from users visiting the website and when to doubt itself) to gain additional information for generating recommendations. The training may utilize reinforced learning from human feedback (RLHF). The training may utilize forced reference (e.g., making the model/AI consider specific ground truths when generating output, such as how a website host of the website may have certain specifics on how an objective is to be achieved verse website hosts of other websites. The training may utilize inter-agent data sharing where agents (e.g., an AI agent using the model to generate recommendations) learn from each other as they are exposed to users and new data.

The platform 400 may utilize the model for employee guidance such as by providing question and answer predictions and optimizations before a call between an employee and a customer (e.g., predictions of what questions the customer may ask, while providing answers that the employee can use during the call). During the call, the model may be used as a synthetic lifeline to help answer questions, provide live coaching, and provide live prospect enrichment by providing content items to the customer during the call. After the call, the model may be used for call scoring and coaching, follow-up content generation such as the creation of new content items for the website that could satisfy an objective of the customer, generative CRM notations (e.g., a notation to add to an object, within a CRM database, representing the customer, the call, a product discussed, a deal, etc.)

The platform 400 may provide a unifying chat experience through site search, live human chat, and generative AI chat. The unifying chat experience may provide a human-with-the-loop (e.g., a single chat interface for users where the AI knows when to ask human agents to join conversations as needed, with context automatically populated for the human agents, and the human agents can then leave once the user's needs are back to where AI has confidence it can handle them again.

The platform 400 may provide multi-perspective generative AI such as for generating recommendations and content items for a website. The multi-perspective generative AI may provide for multi-stakeholder content generation (e.g., generation recommendations and/or content items for an employee of a business, an owner of the business, an IT engineer of the business, etc.), opposing perspectives content generation, and/or management perspective content generation.

The platform 400 may provide for destination AI with daily generative content to include within a website based upon whether users achieved their objectives or if additional content items would help the users achieve their objectives. The platform 400 may support a generative AI metadata markup language used by the model.

The platform 400 may utilize the model to provide synthetic interpersonal interactions such as where a user can practice with a synthetic user (e.g., a hiring manager can practice a hiring interview against synthetic candidates, which can minimize false negatives where a candidate looks bad on paper but may be qualified when talked to). The synthetic interpersonal interactions may provide for synthetic meetings such as a person log where users maintain brief, daily logs about what they're doing and AI Agents attend meetings for them. During meetings, the AI Agents can “raise their hand” if the user they're trained on might have something useful to contribute and summarize what. After meetings, the AI Agent will tell their user if anything they're doing needs to change based on what it heard (e.g. if budgets or priorities or timelines etc. that affect their users' projects are changing and that was discussed in a meeting). The platform 400 may utilize the model to provide super agents such as orchestration AI agents.

The platform 400 may utilize the model for sustainability and social responsibility AI that includes multi-model generative AI CMS for accessibility, enabling users to select specific generative AI models based upon how the models are trained (e.g., anti-biased training) and the data used for training (e.g., ethically sourced training data such as no data from copyrighted works without author permission). The platform may provide trust and transparency with data flow explainability for users (e.g., what data is used and where the data flows and if any data is retained) and/or explainability for chain of thought and chain of reasoning (e.g., enabling a user to ask the AI, backed by the model, to explain how the Al reached a certain conclusion about recommendations or content items generated by the AI, and allows for errors to be corrected, which is used to train the AI and model). The platform 400 provides privacy where a user can force the AI, backed by the model, to believe something about the user (e.g., similar to a forced perspective) and/or to leverage edge computing for users to use the AI agents without data leaving personal hardware systems. The platform 400 may provide value based AI analysis such as for individual values (e.g., analyzing interviews by executives to determine DEI values before applying for a job) and/or organization value (e.g., analyzing policies and other content to aid in user decision making). The platform 400 may provide for automatic safety guardrail generation by analyzing news articles, interviews, case studies, and other sources of content on negative press relating to companies of a specific industry (e.g. social media, SaaS, etc.) and automatically generate AI guardrails intended to avoid similar content items being created for a website about a given company based on their functionality, brand, etc. For example, when building a platform that may be used by minors, the AI, backed by the model, may automatically recognize that the Al/model needs to generate guardrails to avoid harmful usage.

The platform 400 may utilize high dimensional vectors for digital identities for people, tools, and/or AI agents, which are used by the model for generating recommendations and/or content items. The platform 400 may implement persistent learning, such as workflow and context based learning content generation and/or time based management.

In some embodiments, the model recommends pages that are interactive and engaging with a focus on educating visitors on what is this company about, a portfolio of products of the company, and how the company can help them solve their business problem. Building an interactive experience is different from how convention techniques typically create experiences as most of website pages are optimized for search engines and focus on static content. The disclosed innovation creates a web experience that is different from a traditional SaaS product website that contains many links, call to action (CTAs), and copy. The disclosed innovation may be implemented by AI such as an Al agent that changes user behavior on the web and how users discover products. The disclosed innovation enables web and demand tracking on components of these pages and connect this to workflows such as conversion workflows on the website that drive freemium software signups and product demos or starter purchases. The disclosed innovation gathers behavioral data on how users are interacting with these web pages in accordance with privacy policies. The disclosed innovation can scale and leverage data from other marketing channels such as brand, paid, and email marketing campaigns to understand how different sources of traffic might behave differently in an AI powered web experience to continue to optimize and drive demand.

In some embodiments, websites have an incredible amount of content available targeting all sorts of personas. However, it is extremely difficult for users to find information on the website and often visitors have to navigate back to a search to find what the users need. This hinders the ability to educate customers about how product solves their use cases. This innovation improves discoverability, which will increase demand in the form of sign ups and demos. The disclosed innovation provides an AI powered smart navigation overlay (e.g., an interface element populated with content items recommended by a recommendation engine, of the platform 400, using a model). The AI powered smart navigation overlay uses predictive AI to determine optimal journeys for users based on CRM data, qualifying questions, history on the site, and other known factors, which increase user engagement such as driving sign ups and demos. The disclosed innovation provides a virtual demo station that uses generative AI to deliver on-demand, personalized demo videos based on learnings gathered from the AI powered smart navigation overlay and from Gong calls and other sales data. The virtual demo station may be provided through the website as a user navigates the website or provided to the user external from the website.

The disclosed innovation is capable of answer customer question(s) based on a website, blog, and knowledge base content. This capability provides the features of: a crawler that can ingest any URL or piece of text; efficient translation of text to embeddings to recommend relevant content for a question; and generate AI answer based on source of truth.

The disclosed innovation is capable of using private and trainable generative Al models. This capability provides the features of: private hosted open source LLM (Llama 2) on AWS; and training the model on owned data to improve accuracy.

The disclosed innovation is capable of building an understanding of the user, their goals, and persona approximations to provide context to Generative Al. This capability provides the features of: understanding public visitor user paths (clickstream Looker, GA); segmenting visitor behavior to teach the model which content is optimal for which user (CRM data); understanding user chats and Gong calls; and creating user profile context to feed generative AI model for answer generation.

The disclosed innovation is capable of building UX for navigation recommendation leveraging user data. This capability provides the features of: developing new UX paradigm for app anchor; and leveraging generative AI model and APIs based on selected user context and goals.

The disclosed innovation is capable of building a deeper understanding of the user and their goals, as well as third parties. The capability provides the features of: enriching user data with company details via third party integrations (i.e. Clearbit) or deeper CRM integration; and generating contextual third party user personas.

The disclosed innovation is capable of building UX for Virtual Demo Station. The capability provides the features of: cataloging existing product demos, generating embeddings, and providing the ability to understand which video sections to splice; selecting video generation LLM model and set up infrastructure; Developing video demo generation capability given user context and goals; and developing web UX to deliver content to user.

In some embodiments, a method is provided. The method includes identifying contextual user information of a user accessing a first page of a website comprising a plurality of content items; inputting the contextual user information and content information for the plurality of content items of the website into a model trained to generate recommendations of what content items to show users as part of user journeys within websites; generating, by the model using the contextual user information and the content information as input, a sequence of content items to recommend to the user, wherein the sequence of content items are defined as a journey for the user through the website that will result in an increased probability of satisfying an objective for the user to make an informed decision; populating an interface element of the website with one or more content items from the sequence of content items; and in response to the user interfacing with a content item within the interface element, transitioning the website to displaying the content item.

In some embodiments, the method includes detecting the user accessing a second page of the website; generating current contextual information related to the user accessing the website; inputting the current contextual information into the model to generate an updated sequence of content items; and populating the interface element with one or more content items from the sequence of content items.

In some embodiments, the method includes utilizing the model to generate a set of qualifying questions for the user, wherein the model is trained to minimize a number of qualifying questions to include within the set of qualifying questions; populating a user interface with set of qualifying questions; and utilizing user specified answers to one or more qualifying questions within the set of qualifying answers as the contextual user information.

In some embodiments, the method includes evaluating an output, including the sequence of content items, to determine that a recommended content item to show to the user is not included within the website; and generating a notification with instructions to create the recommended content item for inclusion within the website.

In some embodiments, the method includes evaluating an output, including the sequence of content items, to determine that a recommended content item to show to the user is not included within the website; generating the recommended content item; and updating the website to include the recommended content item.

In some embodiments, the method includes hosting a website service for the website and the model within a computing environment for performing localized inferences for generating suggestions of content items to provide users, qualifying questions to ask the users, and guidance for navigating the users through journeys across content items of the website.

In some embodiments, the method includes training the model with user click stream data corresponding to users interacting with content items of the website, wherein the model is trained with information about the users and resulting actions performed by the users in relation to objectives for users navigating through the website.

In some embodiments, the method includes outputting, by the model, the sequence of content items to include content items that similar users viewed along journeys of navigating the website that resulted in the users performing actions related to the objective.

In some embodiments, a computing device is provided. The computing device comprises a memory comprising machine executable code; and a processor coupled to the memory, the processor configured to execute the machine executable code to cause the processor to perform operations comprising: identifying contextual user information of a user accessing a first page of a website comprising a plurality of content items; inputting the contextual user information and content information for the plurality of content items of the website into a model trained to generate recommendations of what content items to show users as part of user journeys within websites; generating, by the model using the contextual user information and the content information as input, a sequence of content items to recommend to the user, wherein the sequence of content items are defined as a journey for the user through the website that will result in an increased probability of satisfying an objective for the user to make an informed decision; populating an interface element of the website with one or more content items from the sequence of content items; and in response to the user interfacing with a content item within the interface element, transitioning the website to displaying the content item.

In some embodiments, the operations include identifying, using the model, a content item that was viewed by a past user having one or more similar attributes as the user, wherein the past user performed an action related to the objective for the user.

In some embodiments, the operations include clustering, using the model, content item of the website and users having similar attributes that performed similar actions after navigating across the website to create clusters; and utilizing the clusters to identify the sequence of content items to recommend to the user.

In some embodiments, the sequence of content items are similar to sequence of content items navigated amongst by similar users as the user given the objective for the user being similar to actions performed by the similar users, and wherein the contextual user information includes previously viewed content and information by the user before visiting the first page.

In some embodiments, the operations include storing the contextual user information within local storage associated with a browser accessing the website as stored contextual user information protected from being accessed by services or analytics other than a recommendation engine hosting the model.

In some embodiments, the interface element is a widget, and the operations include displaying the sequence of content items through the widget, wherein a title, a text description, and an image are displayed for each content item.

In some embodiments, a non-transitory machine readable medium is provided. The non-transitory machine readable medium comprises instructions for performing a method, which when executed by a machine, causes the machine to perform operations comprising: identifying contextual user information of a user accessing a first page of a website comprising a plurality of content items; inputting the contextual user information and content information for the plurality of content items of the website into a model trained to generate recommendations of what content items to show users as part of user journeys within websites; generating, by the model using the contextual user information and the content information as input, a sequence of content items to recommend to the user, wherein the sequence of content items are defined as a journey for the user through the website that will result in an increased probability of satisfying an objective for the user to make an informed decision; populating an interface element of the website with one or more content items from the sequence of content items; and in response to the user interfacing with a content item within the interface element, transitioning the website to displaying the content item.

In some embodiments, the operations include receiving feedback from the user for the content item; and training the model based upon the feedback, wherein a weight used to select or rank the content item is reduced based upon the feedback being negative feedback.

In some embodiments, the operations include receiving feedback from the user for the content item; and modifying a weight associated with the content item to suppress selection of the content item by the model for similar users as the user.

In some embodiments, the operations include receiving feedback from the user for the content item; and modifying a weight associated with a cluster including the content item to suppress select of content items from the cluster by the model for similar users as the user.

In some embodiments, the operations include displaying the sequence of content items through the interface element as a series of representations linking to the content items.

In some embodiments, the operations include requesting feedback from the user as to whether the user performed an action based upon content items navigated by the user leading up to the action being performed.

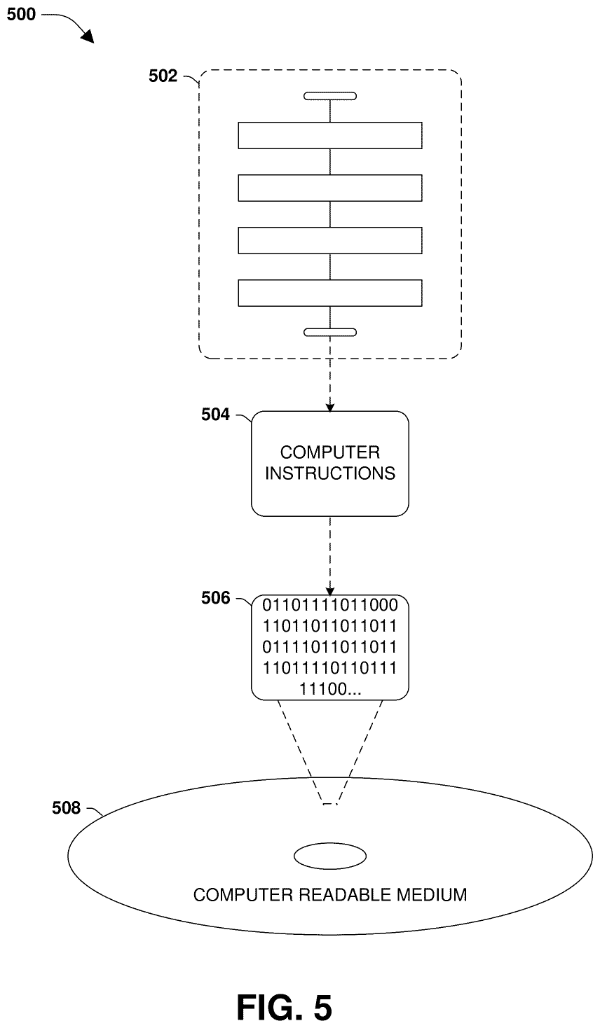

A computer-readable medium comprises processor-executable instructions configured to implement one or more of the techniques presented herein. An example embodiment of a computer-readable medium or a computer-readable device is illustrated in FIG. 5, wherein the implementation 500 comprises a computer-readable medium 508, such as a CD-R, DVD-R, flash drive, a platter of a hard disk drive, etc., on which is encoded computer-readable data 506. This computer-readable data 506, such as binary data comprising at least one of a zero or a one, in turn comprises a set of computer instructions 504 configured to operate according to one or more of the principles set forth herein. In some embodiments, the processor-executable computer instructions 504 are configured to perform a method 502, for example. In some embodiments, the processor-executable instructions 504 are configured to implement a system, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims. As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. A component may reside within a process and/or thread of execution and a component may be localized on one computer and/or distributed between two or more computers. Furthermore, the claimed subject matter may be implemented as a method, apparatus, or article of manufacture using programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Many modifications may be made to this configuration without departing from the scope or spirit of the claimed subject matter.

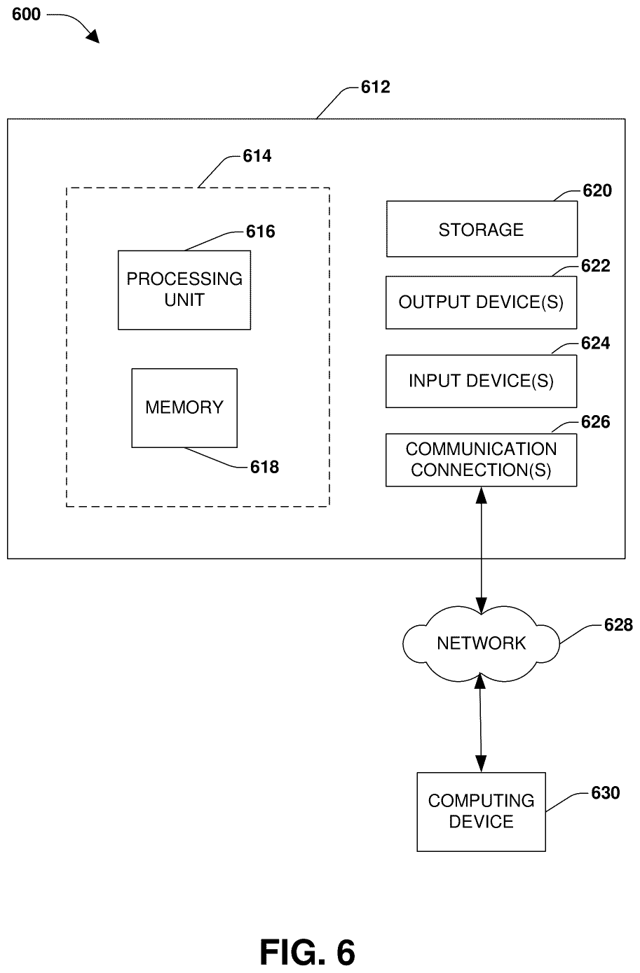

FIG. 6 and the following discussion provide a brief, general description of a suitable computing environment to implement embodiments of one or more of the provisions set forth herein. The operating environment of FIG. 6 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like. Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 6 illustrates an example of a system 600 comprising a computing device 612 configured to implement one or more embodiments provided herein. In one configuration, computing device 612 includes at least one processing unit 616 and memory 618. Depending on the exact configuration and type of computing device, memory 618 may be volatile (such as RAM, for example), non-volatile (such as ROM, flash memory, etc., for example) or some combination of the two. This configuration is illustrated in FIG. 6 by dashed line 614. In other embodiments, device 612 may include additional features and/or functionality. For example, device 612 may also include additional storage (e.g., removable and/or non-removable) including, but not limited to, magnetic storage, optical storage, and the like. Such additional storage is illustrated in FIG. 6 by storage 620. In one embodiment, computer readable instructions to implement one or more embodiments provided herein may be in storage 620. Storage 620 may also store other computer readable instructions to implement an operating system, an application program, and the like. Computer readable instructions may be loaded in memory 618 for execution by processing unit 616, for example. The term “computer readable media” as used herein includes computer storage media. Computer storage media includes volatile and nonvolatile, removable and non-removable media implemented in any method or technology for storage of information such as computer readable instructions or other data. Memory 618 and storage 620 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 612. Computer storage media does not, however, include propagated signals. Rather, computer storage media excludes propagated signals. Any such computer storage media may be part of device 612.

Device 612 may also include communication connection(s) 626 that allows device 612 to communicate with other devices. Communication connection(s) 626 may include, but is not limited to, a modem, a Network Interface Card (NIC), an integrated network interface, a radio frequency transmitter/receiver, an infrared port, a USB connection, or other interfaces for connecting computing device 612 to other computing devices. Communication connection(s) 626 may include a wired connection or a wireless connection. Communication connection(s) 626 may transmit and/or receive communication media. The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal. Device 612 may include input device(s) 624 such as keyboard, mouse, pen, voice input device, touch input device, infrared cameras, video input devices, and/or any other input device. Output device(s) 622 such as one or more displays, speakers, printers, and/or any other output device may also be included in device 612. Input device(s) 624 and output device(s) 622 may be connected to device 612 via a wired connection, wireless connection, etc. In one embodiment, an input device or an output device from another computing device may be used as input device(s) 624 or output device(s) 622 for computing device 612. Components of computing device 612 may be connected by various interconnects, such as a bus. Components of computing device 612 may be interconnected by a network. For example, memory 618 may be comprised of multiple physical memory units located in different physical locations interconnected by a network. For example, a computing device 630 accessible via a network 628 may store computer readable instructions to implement one or more embodiments provided herein.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments. Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object. Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method, comprising:
identifying contextual user information of a user accessing a first page of a website comprising a plurality of content items;
inputting the contextual user information and content information for the plurality of content items of the website into a model trained to generate recommendations of what content items to show users as part of user journeys within websites;
generating, by the model using the contextual user information and the content information as input, a sequence of content items to recommend to the user, wherein the sequence of content items are defined as a journey for the user through the website that will result in an increased probability of satisfying an objective for the user to make an informed decision;
populating an interface element of the website with one or more content items from the sequence of content items; and
in response to the user interfacing with a content item within the interface element, transitioning the website to displaying the content item.

2. The method of claim 1, comprising:
detecting the user accessing a second page of the website;
generating current contextual information related to the user accessing the website;
inputting the current contextual information into the model to generate an updated sequence of content items; and
populating the interface element with one or more content items from the sequence of content items.

3. The method of claim 1, comprising:
utilizing the model to generate a set of qualifying questions for the user, wherein the model is trained to minimize a number of qualifying questions to include within the set of qualifying questions;
populating a user interface with set of qualifying questions; and
utilizing user specified answers to one or more qualifying questions within the set of qualifying answers as the contextual user information.

4. The method of claim 1, comprising:
evaluating an output, including the sequence of content items, to determine that a recommended content item to show to the user is not included within the website; and
generating a notification with instructions to create the recommended content item for inclusion within the website.

5. The method of claim 1, comprising:
evaluating an output, including the sequence of content items, to determine that a recommended content item to show to the user is not included within the website;
generating the recommended content item; and
updating the website to include the recommended content item.

6. The method of claim 1, comprising:
hosting a website service for the website and the model within a computing environment for performing localized inferences for generating suggestions of content items to provide users, qualifying questions to ask the users, and guidance for navigating the users through journeys across content items of the website.

7. The method of claim 1, comprising:
training the model with user click stream data corresponding to users interacting with content items of the website, wherein the model is trained with information about the users and resulting actions performed by the users in relation to objectives for users navigating through the website.

8. The method of claim 1, comprising:
outputting, by the model, the sequence of content items to include content items that similar users viewed along journeys of navigating the website that resulted in the users performing actions related to the objective.

9. A computing device comprising:
a memory comprising machine executable code; and
a processor coupled to the memory, the processor configured to execute the machine executable code to cause the processor to perform operation comprising:
identifying contextual user information of a user accessing a first page of a website comprising a plurality of content items;
inputting the contextual user information and content information for the plurality of content items of the website into a model trained to generate recommendations of what content items to show users as part of user journeys within websites;
generating, by the model using the contextual user information and the content information as input, a sequence of content items to recommend to the user, wherein the sequence of content items are defined as a journey for the user through the website that will result in an increased probability of satisfying an objective for the user to make an informed decision;
populating an interface element of the website with one or more content items from the sequence of content items; and
in response to the user interfacing with a content item within the interface element, transitioning the website to displaying the content item.

10. The computing device of claim 9, wherein the operations comprise:
identifying, using the model, a content item that was viewed by a past user having one or more similar attributes as the user, wherein the past user performed an action related to the objective for the user.

11. The computing device of claim 9, wherein the operations comprise:
clustering, using the model, content item of the website and users having similar attributes that performed similar actions after navigating across the website to create clusters; and
utilizing the clusters to identify the sequence of content items to recommend to the user.

12. The computing device of claim 9, wherein the sequence of content items are similar to sequences of content items navigated amongst by similar users as the user given the objective for the user being similar to actions performed by the similar users, and wherein the contextual user information includes previously viewed content and information by the user before visiting the first page.

13. The computing device of claim 9, wherein the operations comprise:
storing the contextual user information within local storage associated with a browser accessing the website as stored contextual user information protected from being accessed by services or analytics other than a recommendation engine hosting the model.

14. The computing device of claim 9, wherein the interface element is a widget, and wherein the operations comprise:
displaying the sequence of content items through the widget, wherein a title, a text description, and an image are displayed for each content item.

15. A non-transitory machine-readable storage medium comprising instructions that when executed by a machine, causes the machine to perform operations comprising:
identifying contextual user information of a user accessing a first page of a website comprising a plurality of content items;
inputting the contextual user information and content information for the plurality of content items of the website into a model trained to generate recommendations of what content items to show users as part of user journeys within websites;
generating, by the model using the contextual user information and the content information as input, a sequence of content items to recommend to the user, wherein the sequence of content items are defined as a journey for the user through the website that will result in an increased probability of satisfying an objective for the user to make an informed decision;
populating an interface element of the website with one or more content items from the sequence of content items; and
in response to the user interfacing with a content item within the interface element, transitioning the website to displaying the content item.

16. The non-transitory machine-readable storage medium of claim 15, wherein the operations comprise:
receiving feedback from the user for the content item; and
training the model based upon the feedback, wherein a weight used to select or rank the content item is reduced based upon the feedback being negative feedback.

17. The non-transitory machine-readable storage medium of claim 15, wherein the operations comprise:
receiving feedback from the user for the content item; and
modifying a weight associated with the content item to suppress selection of the content item by the model for similar users as the user.

18. The non-transitory machine-readable storage medium of claim 15, wherein the operations comprise:
receiving feedback from the user for the content item; and
modifying a weight associated with a cluster including the content item to suppress select of content items from the cluster by the model for similar users as the user.

19. The non-transitory machine-readable storage medium of claim 15, wherein the operations comprise:
displaying the sequence of content items through the interface element as a series of representations linking to the content items.

20. The non-transitory machine-readable storage medium of claim 15, wherein the operations comprise:
requesting feedback from the user as to whether the user performed an action based upon content items navigated by the user leading up to the action being performed.
